(19) United States
(12) Patent Application Publication
(10) Pub. No.: US 2022/0292131 A1
(43) Pub. Date: Sep. 15, 2022

(54) METHOD, APPARATUS AND SYSTEM FOR RETRIEVING IMAGE

(71) Applicant: Beijing Baidu Netcom Science Technology Co., Ltd., Beijing (CN)

(72) Inventors: Ruibin BAI, Beijing (CN); Xiang WEI, Beijing (CN); Yipeng SUN, Beijing (CN); Kun YAO, Beijing (CN); Jingtuo LIU, Beijing (CN); Junyu HAN, Beijing (CN)

(21) Appl. No.: 17/826,760

(22) Filed: May 27, 2022

(30) Foreign Application Priority Data
Aug. 17, 2021 (CN) 202110943222.7

(51) Int. Cl. G06F 16/583; G06V 10/74; G06V 10/44; G06F 16/535

(52) U.S. Cl. CPC G06F 16/583; G06V 10/74; G06V 10/443; G06F 16/535

(57) ABSTRACT

A method, apparatus and system for retrieving an image is provided, the method comprises: detecting, in response to receiving a query request comprising a target image, a target subject from the target image; extracting a subject feature from the target subject if a confidence level of a detection box of the detected target subject is greater than a first threshold, the subject feature comprising an identical feature, a similar feature and a category; performing matching on the subject feature of the target image and a subject feature of a candidate image pre-stored in a database, to obtain a similarity score and an identicalness score of the candidate image; and selecting, according to the similarity score and the identicalness score, a predetermined number of candidate images as a search result for output.

### CROSS-REFERENCE TO RELATED APPLICATIONS

This application claims priority to Chinese Patent Application No. 202110943222.7, filed with the China National Intellectual Property Administration (CNIPA) on Aug. 17, 2021, the contents of which are incorporated herein by reference in their entirety.

### TECHNICAL FIELD

The present disclosure relates to the field of artificial intelligence technology, and specifically to the fields of computer vision and deep learning technologies, and can be applied to scenarios such as a graphics processing scenario and an image recognition scenario.

### BACKGROUND

A commodity image retrieval technology refers to searching a commodity library using an image photographed by a user to find an identical or similar commodity for a commodity sale or recommendation on a related commodity, which improves the convenience of searching and finding the commodity, thereby optimizing the purchasing experience of the user. A commodity retrieval is the important application of a mobile visual search in e-commerce. The development of commodity image retrieval not only provides convenience for the shopping of the user, but also promotes the development of e-commerce to the mobile terminal.

A common commodity retrieval scheme is a commodity image-based retrieval scheme. According to the image inputted by the user, a retrieval system returns the identical or similar commodity.

### SUMMARY

The present disclosure provides a method and apparatus for retrieving an image, a device, a storage medium and a computer program product.

In a first aspect, embodiments of the present disclosure provide a method for retrieving an image, comprising: detecting, in response to receiving a query request comprising a target image, a target subject from the target image; extracting a subject feature from the target subject if a confidence level of a detection box of the detected target subject is greater than a first threshold, the subject feature comprising an identical feature, a similar feature and a category; performing matching on the subject feature of the target image and a subject feature of a candidate image pre-stored in a database, to obtain a similarity score and an identicalness score of the candidate image; and selecting, according to the similarity score and the identicalness score, a predetermined number of candidate images as a search result for output.

In a second aspect, embodiments of the present disclosure provide an apparatus for retrieving an image, comprising: a detecting unit, configured to detect, in response to receiving a query request comprising a target image, a target subject from the target image; an extracting unit, configured to extract a subject feature from the target subject if a confidence level of a detection box of the detected target subject is greater than a first threshold, the subject feature comprising an identical feature, a similar feature and a category; a matching unit, configured to perform matching on the subject feature of the target image and a subject feature of a candidate image pre-stored in a database, to obtain a similarity score and an identicalness score of the candidate image; and an outputting unit, configured to select, according to the similarity score and the identicalness score, a predetermined number of candidate images as a search result for output.

In a third aspect, embodiments of the present disclosure provide a system for retrieving an image, comprising: a unified access layer, configured to receive a query request comprising a target image, hand over the query request to an advanced search layer for processing, and output a search result returned by the advanced search layer; the advanced search layer, configured to extract a feature of the target image, hand over the feature to a basic search layer for processing, and return a search result obtained by combining candidate images received from the basic search layer to the unified access layer; and the basic search layer, comprising at least one shard, each of which is configured to find a matching candidate image in a database stored in a local disk according to the feature provided by the advanced search layer, and return a predetermined number of candidate images with a highest similarity score and a highest identicalness score.

In a fourth aspect, embodiments of the present disclosure provide an electronic device, comprising: one or more processors; and a memory, storing one or more programs, wherein the one or more programs, when executed by the one or more processors, cause the one or more processors to implement the method provided by the first aspect.

In a fifth aspect, embodiments of the present disclosure provide a computer-readable medium, storing a computer program thereon, wherein the program, when executed by a processor, causes the processor to implement the method provided by the first aspect.

In a sixth aspect, an embodiment of the present disclosure provides a computer program product, comprising a computer program, wherein the computer program, when executed by a processor, implements the method provided by the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a diagram of an exemplary system architecture in which an embodiment of the present disclosure may be applied;

FIG. 2 is a flowchart of an embodiment of a method for retrieving an image according to the present disclosure;

FIG. 3 is a schematic diagram of an application scenario of the method for retrieving an image according to the present disclosure;

FIG. 4 is a flowchart of another embodiment of the method for retrieving an image according to the present disclosure;

FIG. 5 is a schematic structure diagram of an embodiment of an apparatus for retrieving an image according to the present disclosure; and

FIG. 6 is a schematic structure diagram of a computer system of an electronic device adapted to implement the embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

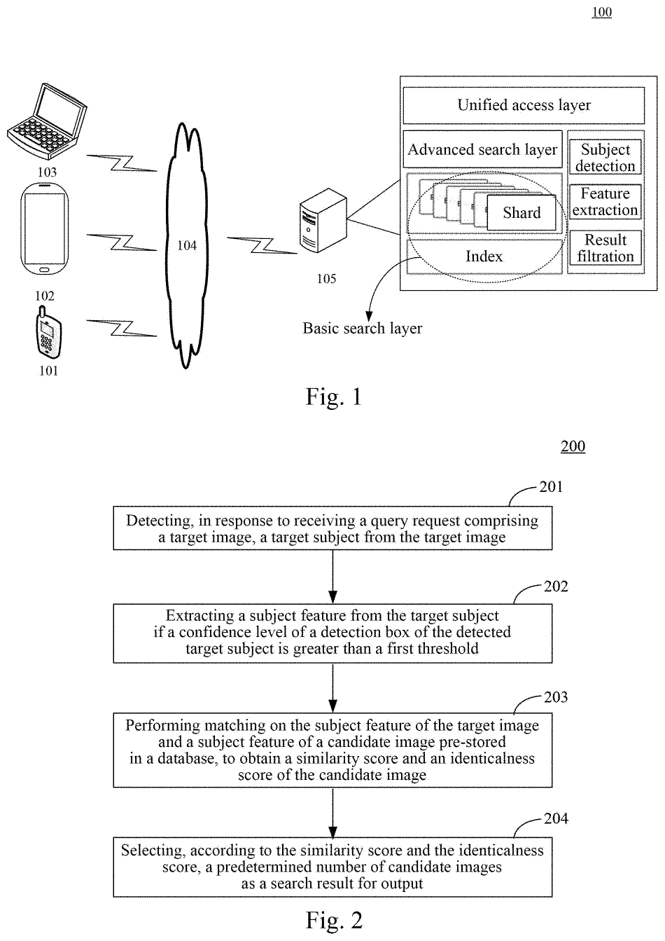

FIG. 1 illustrates an exemplary system architecture 100 in which an embodiment of a method for retrieving an image or an apparatus for retrieving an image according to the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, for example, wired or wireless communication links, or optical fiber cables.

A user may use the terminal devices 101, 102 and 103 to interact with the server 105 via the network 104, to receive or send a message, etc. Various communication client applications (e.g., a webpage browser application, a shopping application, a search application, an instant communication tool, a mailbox client, and social platform software) may be installed on the terminal devices 101, 102 and 103.

The terminal devices 101, 102 and 103 may be hardware or software. When being the hardware, the terminal devices 101, 102 and 103 may be various electronic devices having a display screen and supporting webpage browsing, the electronic devices including, but not limited to, a smartphone, a tablet computer, an e-book reader, an MP3 player (Moving Picture Experts Group Audio Layer III), an MP4 (Moving Picture Experts Group Audio Layer IV) player, a laptop portable computer, a desktop computer, and the like. When being the software, the terminal devices 101, 102 and 103 may be installed in the above listed electronic devices. The terminal devices 101, 102 and 103 may be implemented as a plurality of pieces of software or a plurality of software modules (e.g., software or software modules for providing a distributed service), or may be implemented as a single piece of software or a single software module, which will not be specifically limited here.

The server 105 may be a server providing various services, for example, a backend search server providing a search result for an image submitted by the terminal devices 101, 102 and 103. The backend search server may perform processing such as an analysis on received data such as a search request, and feed back a processing result (e.g., a search result) to the terminal devices.

A system for retrieving an image is installed on the server 105. The system includes the following layers:

1. A unified access layer, configured to receive a query request comprising a target image, hand over the query request to an advanced search layer for processing, and output the search result returned by the advanced search layer. The unified access layer can be implemented by Python and PHP, and is the final interface layer to the outside. In addition, the unified access layer may further be responsible for pre-processing, accessing a back-end service, and post-processing.

2. The advanced search layer (abbreviated as AS), configured to extract a feature of the target image, hand over the feature to a basic search layer for processing, and return a search result obtained by combining candidate images received from the basic search layer to the unified access layer. The advanced search layer may first detect a subject and then extract the feature. The search result may further be filtered and then returned to the unified access layer.

3. The basic search layer, includes at least one shard, each of which is configured to find a matching candidate image in a database stored in a local disk according to the feature provided by the advanced search layer, and return a predetermined number of candidate images with a highest similarity score and a highest identicalness score. The shard is responsible for loading or reading an index from the disk, retrieving and scoring the index according to the feature provided by the AS, and finally returning K results with a highest score. A request is received at the basic search (abbreviated as BS), i.e., each shard in the BS. Since the each shard is part of the index, the request is always sent to the BS of all different shards. For example, if TOP 200 results are finally required, the each shard retrieves TOP 200 results according to the request. In this way, the TOP 200 in the general index can be obtained at the AS layer.

It should be noted that the server may be hardware or software. When being the hardware, the server may be implemented as a distributed server cluster composed of a plurality of servers, or may be implemented as a single server. When being the software, the server may be implemented as a plurality of pieces of software or a plurality of software modules (e.g., software or software modules for providing a distributed service), or may be implemented as a single piece of software or a single software module, which will not be specifically limited here. The server may alternatively be a server of a distributed system, or a server combined with a blockchain. The server may alternatively be a cloud server, or an intelligent cloud computing server or intelligent cloud host with the artificial intelligence technology.

It should be noted that the method for retrieving an image provided in the embodiments of the present disclosure is generally performed by the server 105. Correspondingly, the apparatus for retrieving an image is generally provided in the server 105.

It should be appreciated that the numbers of the terminal devices, the networks and the servers in FIG. 1 are merely illustrative. Any number of terminal devices, networks and servers may be provided based on actual requirements.

Further referring to FIG. 2, FIG. 2 illustrates a flow 200 of an embodiment of a method for retrieving an image according to the present disclosure. The method for retrieving an image includes the following steps:

Step 201, detecting, in response to receiving a query request comprising a target image, a target subject from the target image.

In this embodiment, an executing body (e.g., the server shown in FIG. 1) of the method for retrieving an image may receive, by means of a wired connection or a wireless connection, the query request including the target image from a terminal with which a user performs an image search. The target subject may be detected from the target image by various means in the existing technology. For example, the detection is performed through a detection model. A corresponding detection model may be selected according to the type of the target subject. If the target subject is a commodity, a large number of commodity images may be used as a sample in advance to train and predict a commodity detection model. Then, at the time of detection, the target image is inputted into the commodity detection model, and thus, the commodity body can be detected from the target image.

Alternatively, before the detection, a preprocessing operation such as an image size adjustment performed on the image inputted by the user is to make the minimum side length less than or equal to 1000 by default, so as to avoid that the image transmitted to the detection model and a feature extraction model is too large. Then, a target subject detection is performed through the detection model. When a plurality of target subjects are detected, a detection box with a small size or confidence level is filtered out. The detection results are sorted according to confidence levels, and TOP 2 results at most can be taken. If the confidence level difference is large, only the TOP 1 result may be taken.

Step 202, extracting a subject feature from the target subject if a confidence level of a detection box of the detected target subject is greater than a first threshold.

In this embodiment, if the confidence level of the detection box of the detected target subject is greater than the first threshold, it indicates that the detected target subject is credible and thus the feature can be extracted from the target subject. Otherwise, the feature needs to be extracted from the complete image. For this specific process, reference is made to the flow 400. The subject feature includes an identical feature, a similar feature and a category. The identical feature is a feature used when partial image matching is performed on the target subject, and can be extracted through a convolutional neural network of an attention mechanism. The similar feature is a feature used when complete image matching is performed on the target subject, and can be extracted through the convolutional neural network. The category may refer to a coarse-grained category, e.g., 6 categories (“two-dimensional code, human face, plant, text, dishes, and commodity”). The category may alternatively refer to a fine-grained classification, e.g., 80,000 categories.

The identical feature, the similar feature and the category can be extracted through a feature model. The feature model is a deep learning model trained based on data of the magnitude of ten millions, and has a stronger expressive capability than a traditional machine learning feature model.

Step 203, performing matching on the subject feature of the target image and a subject feature of a candidate image pre-stored in a database, to obtain a similarity score and an identicalness score of the candidate image.

In this embodiment, a large number of candidate images are pre-stored in the database, and the subject feature of each candidate image is pre-extracted. Therefore, the matching can be performed on the subject feature of the target image and the subject feature of the candidate image. The distance between the similar feature of the target image and the similar feature of the candidate image is calculated to obtain the similarity score of the candidate image. The farther the distance is, the lower the score is. The distance between the identical feature of the target image and the identical feature of the candidate image is calculated to obtain the identicalness score of the candidate image. The farther the distance is, the lower the score is. Various existing distance calculation methods such as a cosine distance and a Euclidean distance may be used.

Step 204, selecting, according to the similarity score and the identicalness score, a predetermined number of candidate images as a search result for output.

In this embodiment, the candidate images may be first sorted in a descending order of identicalness scores, and then the candidate images having the same identicalness score may be sorted in a descending order of similarity scores. Then, a predetermined number of top-ranked candidate images are taken as the search result for output. It is also possible to perform the sorting according to weighted sums of the identicalness scores and the similarity scores. The database stores not only the candidate images, but also the related information of the subjects corresponding to the candidate images, and a candidate image with a link may be outputted. After the user clicks on the candidate image, relevant information of the subject corresponding to the candidate image can be jumped to.

Alternatively, a candidate image having a low similarity score and a low identicalness score may be filtered out in advance, without participating in the sorting.

According to the method provided in the above embodiment of the present disclosure, the accuracy of recognizing the images of the identical commodity and similar commodity can be improved without relying on the capabilities of the detection model and the feature extraction model.

In some alternative implementations of this embodiment, the extracting a subject feature from the target subject includes: extracting the similar feature from the target subject through a similar feature model; extracting an identical feature of a partial image from the target subject through an identical feature model; and extracting the category from the target subject through a classification model. The similar feature, the identical feature and the category can be respectively extracted through the similar feature model, the identical feature model and a target classification model. Here, the similar feature model is a deep network-based model, used to calculate the degree of similarity between the target image inputted by the user and the image in the database. The identical feature model is a deep network-based partial image feature, which can more characterize the partial characteristics between the identical commodities. The target classification model is a deep network-based classification model, which classifies the inputted image and is used to filter a request for a non-target in the inputted image.

The similar feature model may be a common convolutional neural network. The identical feature model may be an attention mechanism-based convolutional neural network. In this way, the identical feature and the similar feature can be extracted with pertinence, and thus, the image of the identical commodity and the image of the similar commodity can be more accurately recognized. Accordingly, the matching speed of the images is improved.

The target classification model may alternatively include two models: a coarse-grained classification model and a fine-grained classification model. The coarse-grained classification model may recognize 6 kinds of targets. The fine-grained classification model may recognize 80,000 kinds of targets. In this way, a non-target image can be filtered in advance through the coarse-grained model, avoiding useless work. The two classification models may be respectively used to obtain two classification results.

In some alternative implementations of this embodiment, the method further includes: filtering out a detection box having a detection box size less than a size threshold or having a confidence level less than a second threshold. When a target detection is performed, a plurality of target subjects may be detected, and an incredible target subject may be filtered out according to the size, because the target that the user wants to search for must be intentionally magnified and photographed. In addition, it is also possible to filter out a low-credibility target subject. In this way, the amount of calculation in the subsequent matching process can be reduced, thereby improving the query speed and accuracy.

In some alternative implementations of this embodiment, the method further includes: determining, if a number of detection boxes is greater than 1, a unique target subject according to a position and an area of a detection box of each target subject and the similarity score and the identicalness score of the candidate image. If there may be one or more than one credible target subject after the previous filtering, filtering may be alternatively performed according to the position and the area of the detection box, to retain a target subject which is in the middle of the image and of which the area exceeds a predetermined area threshold. If there is also more than one target subject, filtering is performed again through the similarity score and the identicalness score in the matching process. For example, if the similarity score and identicalness score in the search result of the target subject A are not higher than 0.5, while the similarity score and identicalness score in the search result of the target subject B can be up to 0.9, the target subject B is considered to be the subject that the user wants to search for.

In some alternative implementations of this embodiment, the selecting, according to the similarity score and the identicalness score, a predetermined number of candidate images as a search result for output includes: calculating degrees of matching of the candidate images according to similarity scores and identicalness scores of the candidate images; and selecting, if a first candidate image with a highest degree of matching does not meet a filtering condition, the predetermined number of candidate images in a descending order of the degrees of matching as the search result for output. The weighted sum of the similarity score and the identicalness score of the candidate image may be used as a degree of matching. Here, the weight of the identicalness score may be set to be larger. The candidate image with the highest degree of matching is named as the first candidate image. If the first candidate image meets the filtering condition, it is considered that the image sent by the user is not a type to be recognized (e.g., not a commodity image), and thus, the search result is rejected to be returned. If some parameters of the first candidate image do not meet the filtering condition, the search result may be outputted. In this way, the recognition rejection function can be realized, and thus, the search result is not outputted for a non-target image input.

In some alternative implementations of this embodiment, the filtering condition includes at least one of the following items:

Five sets of filtering conditions are listed below. Here, “first,” “second” . . . are used to distinguish thresholds, and refer to the descending order of the thresholds. That is, a first identicalness threshold<a second identicalness threshold<a third identicalness threshold<a fourth identicalness threshold<a fifth identicalness threshold, and a first similarity threshold<a second similarity threshold<a third similarity threshold<a fourth similarity threshold<a fifth similarity threshold.

1. The identicalness score of the first candidate image is less than the first identicalness threshold, and the similarity score of the first candidate image is less than the first similarity threshold. Different thresholds are set by the identicalness score, similarity score, etc. in the returned Top 1 result, and coarse screening is performed.

2. The identicalness score of the first candidate image is less than the second identicalness threshold, and the similarity score of the first candidate image is less than the second similarity threshold. Moreover, both the coarse-grained category of the target subject and the coarse-grained category of the first candidate image belong to a predetermined coarse-grained category. There may be two classification models: a coarse-grained model outputting coarse-grained categories (e.g., six categories) and a fine-grained model outputting fine-grained categories (e.g., 80,000 categories), of which the main purpose is to filter a non-target category. For example, if the target is a commodity, a non-commodity category (two-dimensional code, human face, plant, text, and dishes) can be filtered out.

3. The identicalness score of the first candidate image is less than the third identicalness threshold, and the similarity score of the first candidate image is less than the third similarity threshold. Moreover, the difference between the fine-grained category of the target subject and the fine-grained category of the first candidate image is greater than a predetermined difference threshold. For example, if the probability that the fine-grained category of the target subject refers to a coat is 0.9, and the probability that the fine-grained category of the first candidate image refers to a coat is 0.05, the difference is too large, and the matching TOP 1 result is not credible, and accordingly, the remaining results are less credible. Therefore, all the candidate images are filtered out.

4. The identicalness score of the first candidate image is less than the fourth identicalness threshold, and the similarity score of the first candidate image is less than the fourth similarity threshold. Moreover, both the frequency at which the fine-grained category of the target subject belongs to a predetermined fine-grained category and the frequency at which the fine-grained category of the first candidate image belongs to the predetermined fine-grained category are greater than a predetermined frequency threshold. There are many levels of categories, and the frequency of occurrence of an upper level of category can be counted. For example, non-commodity categories such as “book cover,” “screenshot,” “unnatural image,” “simple drawing,” “pathological image,” “bottled drinks,” “architecture” and “hardware product” are filtered.

5. If the first candidate image is derived from an e-commerce business, the identicalness score of the first candidate image is less than the fifth identicalness threshold, and the similarity score of the first candidate image is less than the fifth similarity threshold. Moreover, the fine-grained category of the target subject belongs to a predetermined item category. The commodity category easily mis-recognized in an e-commerce scenario can be filtered out, for example, “books,” “clothing and underwear,” “automobile supplies,” “gift bags,” and “toy musical instruments.”

The non-target image can be filtered out through the above filtering conditions, and a recall result that is truly consistent with the intent of the user can be returned.

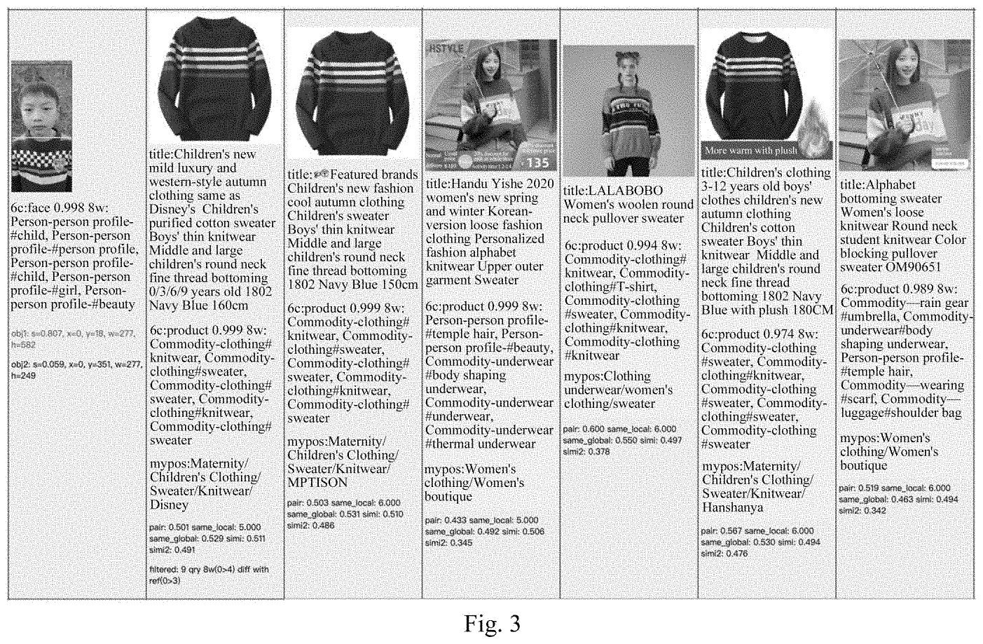

Further referring to FIG. 3, FIG. 3 is a schematic diagram of an application scenario of the method for retrieving an image according to this embodiment. In the application scenario of FIG. 3, a user inputs the left-most image through a terminal. The terminal uploads the image to a server, and then the server first performs a subject detection, thus detecting two subjects, and then filters out one subject according to the areas s of the subjects to retain the human body region. The features of the human body are then extracted and classified to obtain six coarse-grained classification results and 80,000 fine-grained classification results. Matching is performed on the human body region image and an image in a database to obtain the identicalness score and similarity score of each candidate image (the pairing score can further be calculated according to the pairing features in the features of the complete image). Sorting is then performed, thus obtaining the TOP 1 result that is the second image from the left. Whether the image inputted by the user is a commodity image is determined according to the TOP 1 result. If the TOP 1 result does not satisfy a filtering condition, the search result may be outputted, otherwise, the search result is rejected to be outputted.

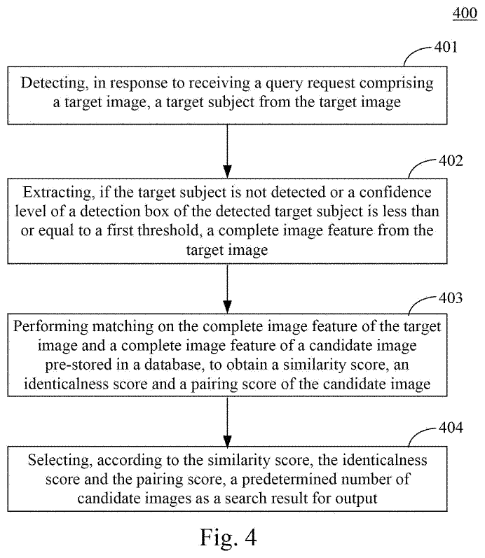

Further referring to FIG. 4, FIG. 4 illustrates a flow 400 of another embodiment of the method for retrieving an image. The flow 400 of the method for retrieving an image includes the following steps:

Step 401, detecting, in response to receiving a query request comprising a target image, a target subject from the target image.

Step 401 is substantially the same as step 201, and thus will not be repeatedly described here.

Step 402, extracting, if the target subject is not detected or a confidence level of a detection box of the detected target subject is less than or equal to a first threshold, a complete image feature from the target image, the complete image feature comprising an identical feature, a similar feature, a category and a pairing feature.

In this embodiment, the way in which the identical feature, the similar feature and the category are extracted is substantially the same as that in step 202, and thus will not be repeatedly described here. The pairing feature is similar to the similar feature, but with less content. The pairing feature is a feature used to determine whether two images are pairing. The pairing feature can be extracted through a pairing model. The pairing model is also a convolutional neural network, but smaller in structure than the similar feature model.

Step 403, performing matching on the complete image feature of the target image and a complete image feature of a candidate image pre-stored in a database, to obtain a similarity score, an identicalness score and a pairing score of the candidate image.

In this embodiment, the process of calculating the similarity score and the identicalness score is substantially the same as that in step 203, and thus will not be repeatedly described here. The pairing score is calculated according to the distance between the pairing features, and the farther the distance is, the lower the pairing score is. Various existing distance calculation methods such as a cosine distance and a Euclidean distance may be used.

Step 404, selecting, according to the similarity score, the identicalness score and the pairing score, a predetermined number of candidate images as a search result for output.

In this embodiment, a degree of matching may be calculated according to the weighted sum of the similarity score, the identicalness score and the pairing score, and then the predetermined number of candidate images are selected in a descending order of degrees of matching as the search result for output. In the filtering condition, the threshold of the pairing score may also be set in combination with the identicalness score and the similarity score. For example, the first set of filtering conditions may be set to: the identicalness score of the first candidate image being less than a first identicalness threshold, the similarity score of the first candidate image being less than a first similarity threshold, and the pairing score of the first candidate image being less than a first pairing threshold.

It can be seen from FIG. 4 that, as compared with the embodiment corresponding to FIG. 2, the flow 400 of the method for retrieving an image in this embodiment reflects that the complete image feature is extracted and the pairing feature is added in the case where no credible target subject is detected. Therefore, the accuracy of the matching and finding can be improved. In addition, the phenomenon that random matching is performed when no credible target subject is detected is avoided.

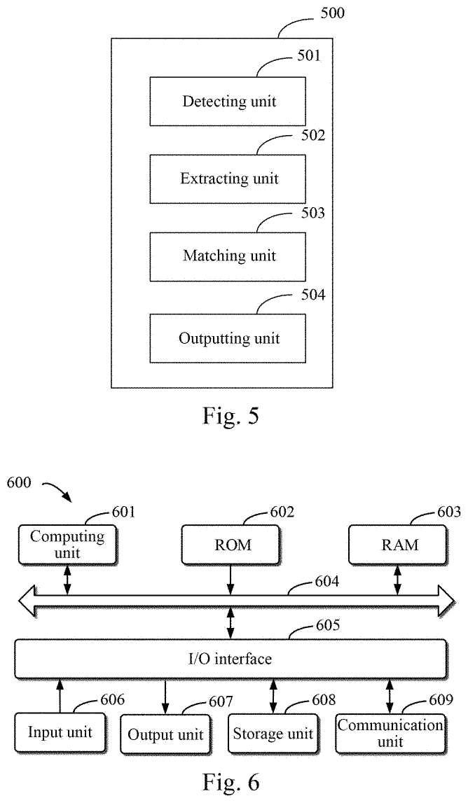

Further referring to FIG. 5, as an implementation of the method shown in the above drawings, the present disclosure provides an embodiment of an apparatus for retrieving an image. The embodiment of the apparatus corresponds to the embodiment of the method shown in FIG. 2, and the apparatus may be applied in various electronic devices.

As shown in FIG. 5, the apparatus 500 for retrieving an image in this embodiment includes: a detecting unit 501, an extracting unit 502, a matching unit 503 and an outputting unit 504. Here, the detecting unit 501 is configured to detect, in response to receiving a query request comprising a target image, a target subject from the target image. The extracting unit 502 is configured to extract a subject feature from the target subject if a confidence level of a detection box of the detected target subject is greater than a first threshold, the subject feature comprising an identical feature, a similar feature and a category. The matching unit 503 is configured to perform matching on the subject feature of the target image and a subject feature of a candidate image pre-stored in a database, to obtain a similarity score and an identicalness score of the candidate image. The outputting unit 504 is configured to select, according to the similarity score and the identicalness score, a predetermined number of candidate images as a search result for output.

In this embodiment, for specific processes of the detecting unit 501, the extracting unit 502, the matching unit 503 and the outputting unit 504 in the apparatus 500 for retrieving an image, reference may be made to step 201, step 202, step 203 and step 204 in the corresponding embodiment of FIG. 2.

In some alternative implementations of this embodiment, the extracting unit 502 is further configured to: extract, if the target subject is not detected or the confidence level of the detection box of the detected target subject is less than or equal to the first threshold, a complete image feature from the target image, the complete image feature comprising an identical feature, a similar feature, a category and a pairing feature. The matching unit 503 is further configured to: perform matching on the complete image feature of the target image and a complete image feature of the candidate image pre-stored in the database, to obtain a similarity score, an identicalness score and a pairing score of the candidate image. The outputting unit 504 is further configured to:

select, according to the similarity score, the identicalness score and the pairing score, the predetermined number of candidate images as the search result for output.

In some alternative implementations of this embodiment, the extracting unit 502 is further configured to: extract the similar feature from the target subject through a similar feature model; extract an identical feature of a partial image from the target subject through an identical feature model; and extract the category from the target subject through a classification model.

In some alternative implementations of this embodiment, the apparatus 500 further includes a filtering unit (not shown), configured to: filter out a detection box having a detection box size less than a size threshold or having a confidence level less then a second threshold.

In some alternative implementations of this embodiment, the filtering unit is further configured to: determine, if a number of detection boxes is greater than 1, a unique target subject according to a position and an area of a detection box of each target subject and the similarity score and the identicalness score of the candidate image.

In some alternative implementations of this embodiment, the outputting unit 504 is further configured to: calculate degrees of matching of the candidate images according to similarity scores and identicalness scores of the candidate images; and select, if a first candidate image with a highest degree of matching does not meet a filtering condition, the predetermined number of candidate images in a descending order of the degrees of matching as the search result for output.

In some alternative implementations of this embodiment, the filtering condition includes at least one of: an identicalness score of the first candidate image being less than a first identicalness threshold, and a similarity score of the first candidate image being less than a first similarity threshold; the identicalness score of the first candidate image being less than a second identicalness threshold, the similarity score of the first candidate image being less than a second similarity threshold, and both a coarse-grained category of the target subject and a coarse-grained category of the first candidate image belonging to a predetermined coarse-grained category; the identicalness score of the first candidate image being less than a third identicalness threshold, the similarity score of the first candidate image being less than a third similarity threshold, and a difference between a fine-grained category of the target subject and a fine-grained category of the first candidate image being greater than a predetermined difference threshold; the identicalness score of the first candidate image being less than a fourth identicalness threshold, the similarity score of the first candidate image being less than a fourth similarity threshold, and both a frequency at which the fine-grained category of the target subject belongs to a predetermined fine-grained category and a frequency at which the fine-grained category of the first candidate image belongs to the predetermined fine-grained category being greater than a predetermined frequency threshold; or if the first candidate image is derived from an e-commerce business, the identicalness score of the first candidate image being less than a fifth identicalness threshold, the similarity score of the first candidate image being less than a fifth similarity threshold, and the fine-grained category of the target subject belonging to a predetermined item category.

In the technical solution of the present disclosure, the acquisition, storage, application, etc. of the personal information of a user all comply with the provisions of the relevant laws and regulations, and do not violate public order and good customs.

According to an embodiment of the present disclosure, the present disclosure further provides an electronic device, a readable storage medium and a computer program product.

According to the method, apparatus and system for retrieving an image provided by the embodiments of the present disclosure, the searching and the matching are performed through the identical feature and the similar feature, and thus, the identical commodity or the similar commodity can be accurately returned, thereby satisfying the intent of the user.

The electronic device includes: at least one processor; and a storage device, communicated with the at least one processor. Here, the storage device stores an instruction executable by the at least one processor, and the instruction is executed by the at least one processor, to enable the at least one processor to perform the method described in the flow 200 or the flow 400.

A non-transitory computer readable storage medium stores a computer instruction. Here, the computer instruction is used to cause a computer to perform the method described in the flow 200 or the flow 400.

The computer program product includes a computer program. Here, the computer program, when executed by a processor, implements the method described in the flow 200 or the flow 400.

FIG. 6 is a schematic block diagram of an example electronic device 600 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 6, the device 600 includes a computation unit 601, which may execute various appropriate actions and processes in accordance with a computer program stored in a read-only memory (ROM) 602 or a computer program loaded into a random access memory (RAM) 603 from a storage unit 608. The RAM 603 also stores various programs and data required by operations of the device 600. The computation unit 601, the ROM 602 and the RAM 603 are connected to each other through a bus 604. An input/output (I/O) interface 605 is also connected to the bus 604.

The following components in the device 600 are connected to the I/O interface 605: an input unit 606, for example, a keyboard and a mouse; an output unit 607, for example, various types of displays and a speaker; a storage device 608, for example, a magnetic disk and an optical disk; and a communication unit 609, for example, a network card, a modem, a wireless communication transceiver. The communication unit 609 allows the device 600 to exchange information/data with an other device through a computer network such as the Internet and/or various telecommunication networks.

The computation unit 601 may be various general-purpose and/or special-purpose processing assemblies having processing and computing capabilities. Some examples of the computation unit 601 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 601 performs the various methods and processes described above, for example, the method for retrieving an image. For example, in some embodiments, the method for retrieving an image may be implemented as a computer software program, which is tangibly included in a machine readable medium, for example, the storage device 608. In some embodiments, part or all of the computer program may be loaded into and/or installed on the device 600 via the ROM 602 and/or the communication unit 609. When the computer program is loaded into the RAM 603 and executed by the computation unit 601, one or more steps of the above method for retrieving an image may be performed. Alternatively, in other embodiments, the computation unit 601 may be configured to perform the method for retrieving an image through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for retrieving an image, comprising:
detecting, in response to receiving a query request comprising a target image, a target subject from the target image;
extracting a subject feature from the target subject if a confidence level of a detection box of the detected target subject is greater than a first threshold, the subject feature comprising an identical feature, a similar feature and a category;
performing matching on the subject feature of the target image and a subject feature of a candidate image pre-stored in a database, to obtain a similarity score and an identicalness score of the candidate image; and
selecting, according to the similarity score and the identicalness score, a predetermined number of candidate images as a search result for output.

2. The method according to claim 1, further comprising:
extracting, if the target subject is not detected or the confidence level of the detection box of the detected target subject is less than or equal to the first threshold, a complete image feature from the target image, the complete image feature comprising an identical feature, a similar feature, a category and a pairing feature;
performing matching on the complete image feature of the target image and a complete image feature of the candidate image pre-stored in the database, to obtain a similarity score, an identicalness score and a pairing score of the candidate image; and
selecting, according to the similarity score, the identicalness score and the pairing score, the predetermined number of candidate images as the search result for output.

3. The method according to claim 1, wherein the extracting a subject feature from the target subject comprises:
extracting the similar feature from the target subject through a similar feature model;
extracting an identical feature of a partial image from the target subject through an identical feature model; and
extracting the category from the target subject through a classification model.

4. The method according to claim 1, further comprising:
filtering out a detection box having a detection box size less than a size threshold or having a confidence level less then a second threshold.

5. The method according to claim 4, further comprising:
determining, if a number of detection boxes is greater than 1, a unique target subject according to a position and an area of a detection box of each target subject and the similarity score and the identicalness score of the candidate image.

6. The method according to claim 1, wherein the selecting, according to the similarity score and the identicalness score, a predetermined number of candidate images as a search result for output comprises:
calculating degrees of matching of the candidate images according to similarity scores and identicalness scores of the candidate images; and
selecting, if a first candidate image with a highest degree of matching does not meet a filtering condition, the predetermined number of candidate images in a descending order of the degrees of matching as the search result for output.

7. The method according to claim 6, wherein the filtering condition comprises at least one of:
an identicalness score of the first candidate image being less than a first identicalness threshold, and a similarity score of the first candidate image being less than a first similarity threshold;
the identicalness score of the first candidate image being less than a second identicalness threshold, the similarity score of the first candidate image being less than a second similarity threshold, and both a coarse-grained category of the target subject and a coarse-grained category of the first candidate image belonging to a predetermined coarse-grained category;
the identicalness score of the first candidate image being less than a third identicalness threshold, the similarity score of the first candidate image being less than a third similarity threshold, and a difference between a fine-grained category of the target subject and a fine-grained category of the first candidate image being greater than a predetermined difference threshold;
the identicalness score of the first candidate image being less than a fourth identicalness threshold, the similarity score of the first candidate image being less than a fourth similarity threshold, and both a frequency at which the fine-grained category of the target subject belongs to a predetermined fine-grained category and a frequency at which the fine-grained category of the first candidate image belongs to the predetermined fine-grained category being greater than a predetermined frequency threshold; or
if the first candidate image is derived from an e-commerce business, the identicalness score of the first candidate image being less than a fifth identicalness threshold, the similarity score of the first candidate image being less than a fifth similarity threshold, and the fine-grained category of the target subject belonging to a predetermined item category.

8. A system for retrieving an image, comprising:
a unified access layer, configured to receive a query request comprising a target image, hand over the query request to an advanced search layer for processing, and output a search result returned by the advanced search layer;
the advanced search layer, configured to extract a feature of the target image, hand over the feature to a basic search layer for processing, and return a search result obtained by combining candidate images received from the basic search layer to the unified access layer; and
the basic search layer, comprising at least one shard, each of which is configured to find a matching candidate image in a database stored in a local disk according to the feature provided by the advanced search layer, and return a predetermined number of candidate images with a highest similarity score and a highest identicalness score.

9. An electronic device, comprising:
at least one processor; and
a storage device storing instructions executable by the at least one processor, the instructions, when executed by the at least one processor, cause the at least one processor to perform operations for retrieving an image, the operations comprising:
detecting, in response to receiving a query request comprising a target image, a target subject from the target image;
extracting a subject feature from the target subject if a confidence level of a detection box of the detected target subject is greater than a first threshold, the subject feature comprising an identical feature, a similar feature and a category;
performing matching on the subject feature of the target image and a subject feature of a candidate image pre-stored in a database, to obtain a similarity score and an identicalness score of the candidate image; and
selecting, according to the similarity score and the identicalness score, a predetermined number of candidate images as a search result for output.

10. The device according to claim 9, the operations further comprising:
extracting, if the target subject is not detected or the confidence level of the detection box of the detected target subject is less than or equal to the first threshold, a complete image feature from the target image, the complete image feature comprising an identical feature, a similar feature, a category and a pairing feature;
performing matching on the complete image feature of the target image and a complete image feature of the candidate image pre-stored in the database, to obtain a similarity score, an identicalness score and a pairing score of the candidate image; and
selecting, according to the similarity score, the identicalness score and the pairing score, the predetermined number of candidate images as the search result for output.

11. The device according to claim 9, wherein the extracting a subject feature from the target subject comprises:
extracting the similar feature from the target subject through a similar feature model;
extracting an identical feature of a partial image from the target subject through an identical feature model; and
extracting the category from the target subject through a classification model.

12. The device according to claim 9, the operations further comprising:
filtering out a detection box having a detection box size less than a size threshold or having a confidence level less then a second threshold.

13. The device according to claim 12, the operations further comprising:
determining, if a number of detection boxes is greater than 1, a unique target subject according to a position and an area of a detection box of each target subject and the similarity score and the identicalness score of the candidate image.

14. The device according to claim 9, wherein the selecting, according to the similarity score and the identicalness score, a predetermined number of candidate images as a search result for output comprises:
calculating degrees of matching of the candidate images according to similarity scores and identicalness scores of the candidate images; and
selecting, if a first candidate image with a highest degree of matching does not meet a filtering condition, the predetermined number of candidate images in a descending order of the degrees of matching as the search result for output.

15. The device according to claim 14, wherein the filtering condition comprises at least one of:
an identicalness score of the first candidate image being less than a first identicalness threshold, and a similarity score of the first candidate image being less than a first similarity threshold;
the identicalness score of the first candidate image being less than a second identicalness threshold, the similarity score of the first candidate image being less than a second similarity threshold, and both a coarse-grained category of the target subject and a coarse-grained category of the first candidate image belonging to a predetermined coarse-grained category;
the identicalness score of the first candidate image being less than a third identicalness threshold, the similarity score of the first candidate image being less than a third similarity threshold, and a difference between a fine-grained category of the target subject and a fine-grained category of the first candidate image being greater than a predetermined difference threshold;
the identicalness score of the first candidate image being less than a fourth identicalness threshold, the similarity score of the first candidate image being less than a fourth similarity threshold, and both a frequency at which the fine-grained category of the target subject belongs to a predetermined fine-grained category and a frequency at which the fine-grained category of the first candidate image belongs to the predetermined fine-grained category being greater than a predetermined frequency threshold; or
if the first candidate image is derived from an e-commerce business, the identicalness score of the first candidate image being less than a fifth identicalness threshold, the similarity score of the first candidate image being less than a fifth similarity threshold, and the fine-grained category of the target subject belonging to a predetermined item category.
